(19) United States
(12) Patent Application Publication
(10) Pub. No.: US 2025/0282198 A1
(43) Pub. Date: Sep. 11, 2025

(54) Automatic Climate Control in Motor Vehicle

(71) Applicant: DENSO International America, Inc., Southfield, MI (US)

(72) Inventor: Alfredo Rodriguez, Southfield, MI (US)

(21) Appl. No.: 18/965,352

(22) Filed: Dec. 2, 2024

Related U.S. Application Data
(60) Provisional application No. 63/561,878, filed on Mar. 6, 2024.

(51) Int. Cl. B60H 1/00

(52) U.S. Cl. CPC B60H 1/00807; B60H 1/00664; B60H 1/00814

(57) ABSTRACT

Disclosed herein are embodiments relating to a vehicle AC control system. The system is designed for purposes of controlling and improving the thermal comfort of passengers within the vehicle. The AC control system incorporates at least the following components: at least one heat mapping sensor, at least one position sensor; and at least one temperature sensor. The AC control system is designed to direct airflow to a position within the vehicle, for controlling thermal comfort of at least one passenger within the vehicle.

### CROSS-REFERENCE TO RELATED APPLICATION

This application claim the benefit of U.S. Provisional Application No. 63/561,878 filed Mar. 6, 2024, the entire disclosure of which is incorporated by reference herein.

### TECHNICAL FIELD

The present invention relates to air conditioning systems and components in motor vehicles. More specifically, the present disclosure pertains to control systems for automating climate control in motor vehicle AC systems.

### BACKGROUND

Presently, most air conditioning (AC) systems in vehicles are operated by the driver or passenger of a vehicle through manual means. This typically includes manually controlling the direction of air flow by adjusting the air vents to a desired location. Oftentimes, a driver may experience periods of elevated or reduced temperatures, which can be affected by outside temperatures, hotspots within the car, the incidence of sunlight, and so forth. During normal operation of a vehicle, a driver would typically adjust the direction of the air vents, the temperature and the fan speed manually, often taking all these steps while driving. This unnecessarily creates distracting conditions for a driver, which increase the risk of accidents or other dangerous events.

In light of the current drawbacks, it is necessary to simplify the means by which an occupant of a motor vehicle establishes climate control and thermal comfort. There is a need to automate the means by which a vehicle AC system operates, such that a driver or passenger of a vehicle does not have to manually take multiple steps to maintain thermal comfort while occupying the vehicle.

### SUMMARY

Described herein are embodiments relating to a vehicle AC control system. This system is designed for purposes of controlling and improving the thermal comfort of at least one passenger within the vehicle. In an embodiment, the AC control system disclosed herein incorporates at least the following components: at least one heat mapping camera, at least one position sensor; and at least one temperature sensor. The at least one heat mapping camera, at least one position sensor, and/or at least one temperature sensor provide inputs to a processor of the AC control system, to direct airflow to a position within the motor vehicle, for controlling thermal comfort of at least one passenger within the vehicle.

In an embodiment, a method controlling the thermal comfort of passengers in a vehicle includes identifying an out of range temperature location on at least one passenger, and directing air flow from at least one air vent to the out of range temperature location. The air flow from the at least one air vent continues until a target temperature is reached, and wherein identifying an out of range temperature location comprises detecting an out of range temperature location through at least one heat mapping camera, at least one position sensor, or at least one temperature sensor within the motor vehicle, or a combination thereof.

In an embodiment, an AC control system for a vehicle includes a heat mapping sensor configured to generate a thermal map of a location within the vehicle. A position sensor is configured to identify the location within the vehicle. A temperature sensor configured to detect an air temperature T within the vehicle. A plurality of air vents for directing air flow from a blower. A plurality of servo motors operatively coupled to a respective one of the plurality of air vents, wherein the plurality of servo motors are configured to adjust an orientation of the plurality of air vents. A processor is configured to receive input data from the heat mapping sensor, the position sensor, and the temperature sensor. In response to input data, the processor is programmed to determine an out of range temperature location and to control at least one of the plurality of servo motors for adjusting the orientation of at least one of the plurality of air vents and directing the air flow from the at least one of the plurality of air vents towards the out of range temperature location.

### BRIEF DESCRIPTION OF THE FIGURES

In the following description, details are set forth to provide an understanding of the present disclosure. In some instances, certain systems, structures and techniques have not been described or shown in detail in order not to obscure the disclosure.

FIG. 1 is a block diagram of an air-conditioning (AC) system of a vehicle and an associated control algorithm, according to an embodiment of the present disclosure;

FIG. 2 depicts servo motors for adjusting an orientation of an air vent, according to an embodiment of the present disclosure;

FIG. 3 depicts schematics for air flow rate control via an air nozzle, according to an embodiment of the present disclosure; and

FIG. 4 depicts a method for controlling thermal comfort of the passenger of the vehicle, according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents to the quantities. In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue. The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof. As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.” The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure. As used throughout this description, and in the claims, a list of items joined by the term “at least one of” or “one or more of” can mean any combination of the listed terms. For example, the phrase “at least one of X, Y or Z” can mean X; Y; Z; X and Y; X and Z; Y and Z; or X, Y and Z.

As used herein, the term “out of range temperature” refers to an elevated or lowered temperature profile on an occupant of a vehicle or on an internal location of a vehicle. The out of range temperature in some instances will include hot spots or cold spots, which are higher or lower than a specified target temperature. The out of range temperature can also be temperature that is higher or lower than surrounding temperatures on the passenger or within the vehicle. By way of example, “a processor” programmed to perform various functions refers to one processor programmed to perform each and every function, or more than one processor collectively programmed to perform each of the various functions.

Described herein are embodiments relating to an AC control system for a vehicle. The systems and methods described herein may be used for the automatic control of a general and localized thermal environment for the vehicle to improve thermal comfort of at least one user (e.g., a driver or passenger, etc.) within the vehicle. The vehicle may be an automobile, airplane, helicopter, train, ship, or the like. Accordingly, while the following disclosure generally describes the vehicle with respect to an automobile, one of ordinary skill in the art will understand that the systems and methods of the present disclosure may be applied to other types of vehicles and the compartments of those vehicles.

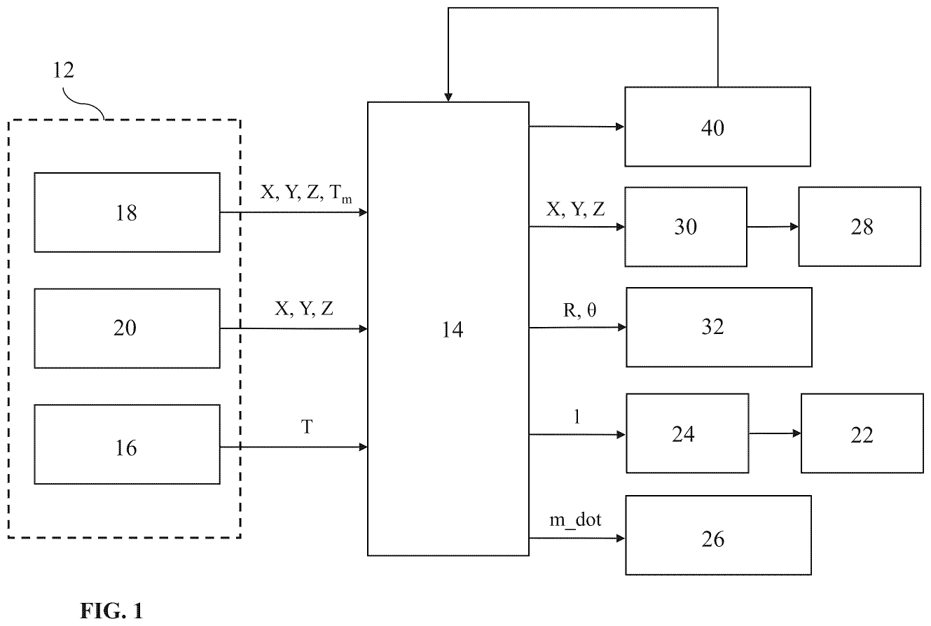

Referring to FIG. 1, in an embodiment, an air-conditioning (AC) system 10 of a vehicle includes a plurality of sensors 12 in communication with a processor 14. In other words, the plurality of sensors 12 are configured to send input data to the processor 14 and/or the processor 14 is communicatively coupled to the plurality of sensors 12 and is configured to receive the input data from the plurality of sensors 12. As will be described in greater detail below, in response to the input data, the processor 14 is configured to adjust a temperature in a position within the vehicle. The plurality of sensors 12 may include a temperature sensor 16, a heat mapping sensor 18, a position sensor 20, or the like, or a combination or sub-combination thereof. The plurality of sensors 12 may be located within the vehicle, such as near a driver side seat, or a front or rear passenger seat.

The temperature sensor 16 is configured to detect, determine, or measure an environmental or air temperature T within an interior of the vehicle (e.g., a cabin, cockpit, etc.). The temperature sensor 16 may be located within or in close proximity to a steering wheel or a driver side seat. In some embodiments, a plurality of temperature sensors 16 are located within the vehicle (e.g., the plurality of temperature sensors 16 may be located in both a front and rear of the vehicle, at various heights or elevations within the vehicle, or positioned so as to be associated with a particular location within the vehicle such as a rear-left passenger seat, or the like). The processor 14 may be configured to determine the environmental temperature T generally and locally to the plurality of temperature sensors 16.

The heat mapping sensor 18 is configured to detect thermal energy and generate thermal map data Tm of an interior of the vehicle, a location or spot within the vehicle, or on a passenger, or the like. For purposes of this disclosure the term passenger is used to include any occupant of the vehicle, including the driver and other occupants not in the driver's position. The location within the vehicle may include a driver side seat, front and/or rear passenger seats, floor space associated with the driver side and/or passenger seats, or the like, or a combination or sub-combination thereof. The spot on the passenger may include the passenger's head, upper body (chest, torso, arms, etc.), lower body (waist, legs, feet, etc.), or the like, or a combination or sub-combination thereof.

The heat mapping sensor 18 may be an infrared (IR) thermal imaging camera, or the like. The heat mapping sensor 18 may be mounted within the vehicle on a driver side location, a passenger side location, a rear vehicle location, or a combination thereof. The heat mapping sensor 18 may be configured to generate the thermal map data Tm (heat or temperature mapping data) of a single passenger or multiple passengers. For example, based on the location of the heat mapping sensor 18, the heat mapping sensor 16 may detect temperature signatures for the single passenger or multiple passengers (e.g., the heat mapping sensor 18 may not be obstructed or prevented from detecting temperature signatures for multiple passengers due to the position of the heat mapping sensor 16 and/or the ability of the heat mapping sensor 18 to rotate or adjust an orientation to view the multiple passengers).

In an embodiment, the heat mapping sensor 18 is a digital infrared thermal imaging camera. In an embodiment, a plurality of heat mapping sensor 18 may be used. For example, the plurality heat mapping sensor 18 may be mounted on a driver side location, a passenger side location, a rear vehicle location, or a combination thereof. The plurality of heat mapping sensor 18 may be assigned to monitor thermal profiles of a plurality of passengers, such as a driver, and/or a front or rear passenger. Alternatively, a single heat mapping sensor 18 may be utilized to monitor the plurality of passengers, such as both a passenger and driver. Similarly, passengers seated in the rear seats of the vehicle may be monitored independently from the front seating passengers, through use of another heat mapping sensor 18 mounted within the vehicle.

The processor 14 is configured receive the thermal map data Tm and identify an out of range temperature location or spot. The out of range temperature location can refer to an elevated temperature (e.g., a hot spot) or a lowered temperature (e.g., a cold spot) relative to the environmental temperature T, an target temperature for the location within the vehicle as compared to other areas of the vehicle, and/or an target temperature for the passenger as compared to the remainder of or a nearby portion of the passenger's body. The target temperature of the passenger may include temperatures for certain areas of the passenger's body and/or whether the certain areas are exposed or covered by clothing. In this way, the processor 14 is programmed to identify or determine a potential area of thermal discomfort for the passenger (i.e., the processor 14 can determine if the passenger is too hot or cold in a particular area). In some embodiments, the out of range temperature location may include an object within the vehicle (e.g., a cooler, electronic device, food, etc.) and the target temperature may include a temperature for preventing damage to the object. Examples herein may describe the invention in terms of elevated temperatures or elevated spots and it should be understood than when the term “elevated” is used, it is intended to refer to an “out of range” temperature spot. It is to be understood that all embodiments while referring to elevated temperatures, similarly function in instances of lowered temperatures or cold spots.

The position sensor 20 is configured to determine, identify, or generate position data (X, Y, Z) of a location or spot within the vehicle, or on a passenger, or the like. For example, the position sensor 20 may be configured to identify position data (X, Y, Z) for the out of range temperature location. The position sensor 20 may also identify a position of the passenger. The position sensor 20 may include LIDAR type sensors, pressure sensors, or the like. In some embodiments, the position sensor 20 may include depth sensors with a monochrome CMOS sensor and an infrared projector for determining the distance of each point on a passenger's body by transmitting invisible near-infrared light and measuring its “time of flight” after it reflects off the body. In some embodiments, the heat mapping sensor 18 may be configured to determine, identify, or generate position data (X, Y, Z) of a location or spot within the vehicle, or on a passenger, or the like.

The processor 14 is configured to receive input data (X, Y, Z, T, Tm) from the plurality of sensors 12, wherein the input data (X, Y, Z, T, Tₘ) includes the air temperature T, the thermal map data Tm, and the position data (X, Y, Z). In response to the input data (X, Y, Z, T, Tₘ), the processor 14 is programmed to control and direct airflow to the out of range temperature location. The processor 14 may be programmed to continuously identify an out of range temperature location within the vehicle and determine when the elevated temperate of the out of range temperature location has been adjusted to an expected or desired temperature.

The processor 14 and any associated controller can be configured to receive information from the plurality of sensors 12 disclosed herein, process the information, and output instructions to direct airflow, for example. In some embodiments, the processor 14 may be a controller or control unit for an HVAC system. In this disclosure, the terms “controller” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor 14 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor 14 may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/SQL. The computer-executable instructions of the programs may be configured, upon execution by the processor 14, to direct or control air flow within the vehicle by modulating an associated motor, vent or register, or components of the AC system 10, or the like, for example.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, e.g., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”). Such a special purpose circuit may be referred to as a computer processor even if it is not a general-purpose processor.

In an embodiment, the AC system 10 includes a blower 22 for generating air flow to a passenger of the vehicle. The blower 22 may be a centrifugal fan, or the like, and is driven by a blower motor 24. An increase or decrease in an output of the blower motor 24, may increase or decrease a flowrate of the air flow within the AC system 10 and the air flow that reaches the passenger. A refrigerating system 26 is configured to cool the air flow and may include components, such as an evaporator, a compressor, a condenser, an expansion valve, a refrigerant, or the like.

For example, the processor 14 is operatively connected to blower motor 24 and is programmed to increase or decrease the output (1) of the blower motor 24 (e.g., by adjusting a voltage of the blower motor 24) to increase or decrease the flowrate of the air flow within the AC system 10 and to the out of range temperature location. The processor 14 may adjust the output (1) of the blower motor 24 in response to the out of range temperature being significantly elevated from or in close proximity to the target temperature. In some embodiments, the processor 14 sends a blower motor signal to control the blower motor 24 and the blower 22.

The processor 14 is operatively connected to the refrigerating system 26 and is programmed to power on or off the refrigerating system 26 and/or to adjust a flow of the refrigerant (m_dot) within the refrigerating system 26 (e.g., by controlling or adjusting the evaporator, compressor, condenser, expansion valve, or the like). In this way, a temperature of the air flow directed to the out of range temperature location is controlled. The processor 14 may control the flow of the refrigerant (m_dot) by sending instructions to the refrigerating system 26 in response to the input data (X, Y, Z, T, Tₘ) such that the flow rate, mass flow rate, compressor speed, or the like, are adjusted accordingly. In some embodiments, the processor 14 is operatively connected to a heating system within the vehicle (e.g., a heating core connected to a liquid cooling circuit of an engine of the vehicle) and is programmed to activate or deactivate the heating system in response to the out of range temperature being lower than expected.

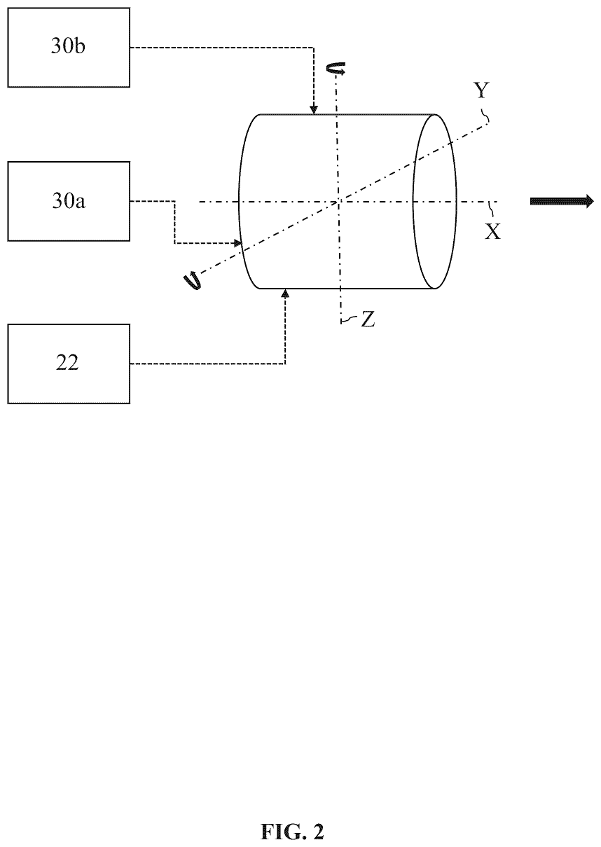

Referring to FIGS. 1 and 2, the air flow may be directed from the blower 22 to an air vent 28 or a plurality of air vents 28 by an air passage(s), duct(s), doors, dampers, valves, or the like. The air vent 28 may be positioned within the vehicle and direct the air flow to the body of the passenger, including the passenger's face, chest, legs, feet, or the like. For example, the air vent 28 may be located on or underneath a dashboard of the vehicle, underneath a seat of the vehicle, on a ceiling of the vehicle, or the like. The air vent 28 may be generally circular, rectangular, or the like.

In an embodiment, the air vent 28 is operatively connected or coupled to a servo motor 30 for controlling a direction of the air flow from the air vent 28 to the passenger or interior of the vehicle. The servo motor 30 controls the air flow direction from the air vent 28 by adjusting an orientation or direction (Xᵥ, Yᵥ, Zᵥ) of the air vent 28. In other words, the servo motor 30 is configured to orientate or rotate the air vent 28 about a Y axis or Z axis of the air vent 28 and the air flow is directed in response to the orientation (Xᵥ, Yᵥ, Zᵥ) of the air vent 28. In some embodiments, a first servo motor 30a may be configured to rotate the air vent 28 about the Y axis and a second servo motor 30b may be configured to rotate the air vent 28 about the Z axis. The plurality of air vents 28 are operatively connected to a respective one of a plurality of servo motors 30.

In an embodiment, the processor 14 is operatively connected to the servo motor 30 and is programmed to instruct the servo motor 30 to adjust the orientation or direction (Xᵥ, Yᵥ, Zᵥ) of the air vent 28 in response to the position data (X, Y, Z) and/or the input data (X, Y, Z, T, Tₘ). In response to instructions from the processor 14, the servo motor 30 adjusts the orientation (Xᵥ, Yᵥ, Zᵥ) of the air vent 28 by rotating the air vent 28 about a Y axis or Z axis such that the air flow from the air vent 28 is directed towards the out of range temperature location. In embodiments, the processor 14 is operatively connected to the plurality of servo motors 30 and is programmed to instruct the plurality of servo motors 30 to adjust the orientation (Xᵥ, Yᵥ, Zᵥ) of the plurality of air vent 28 individually such that the plurality of air vents 28 are directed towards the out of range temperature location. For example, the plurality of air vents 28 may be located on a dashboard of the vehicle and may all be directed toward the legs of a passenger in the driver side seat. In this way, the plurality of air vents 28 act in conjunction with each other to direct the air flow to the out of range temperature location and may more quickly alter the elevated temperature to the target temperature. Directing the plurality of air vents 28 may also alter the out of range temperature location from different directions (e.g., the passenger may feel thermal comfort from two or more sides of their body or part of their body rather than from a single direction via a single air vent 28) and may enable improved temperature adjustment via fluid mechanics (i.e., the multiple air flows from different directions may improve mixing of the environmental air temperature in the out of range temperature location and result in a faster adjustment to the target temperature).

In some embodiments, the processor 14 is programmed to instruct at least one of the plurality of servo motors 30 to adjust the orientation (Xᵥ, Yᵥ, Zᵥ) of at least one of the plurality of air vents 28. For example, air flow from at least one of the plurality of air vents 28 may be obstructed from being effectively directed towards to the out of range temperature location. The processor 14 is programmed to determine whether the air flow from the plurality of air vents 28 may be obstructed or prevented from effectively being directed toward the out of range temperature location and may direct the plurality of air vents 28 (with air flows that would not be obstructed) toward the out of range temperature location via the respective plurality of servo motors 30. In other examples, there may be a plurality of passengers within the vehicle, such as a first passenger and a second passenger, and the out of range temperature location is associated with the first passenger. The processor 14 may be programmed to determine the presence of the plurality of passengers and adjust the plurality of air vents 28 such that at least one of the plurality of air vents 28 is or remains directed toward each of the plurality of passengers. For example, the first passenger is seated in the drive side seat, the second passenger is seated in the front passenger seat, and the plurality of air vents 28 are located on the dashboard of the vehicle. The processor 14 may identify the out of range temperature location on or near the first passenger and direct the at least one of the plurality of air vents 28 toward the out of range temperature location via the associated at least one of the plurality of servo motors 30, wherein at least one of the plurality of air vents 28 is or remains directed towards the second passenger. In this way, the AC system 10 can improve the thermal comfort of a passenger without significantly affecting the thermal comfort of another passenger.

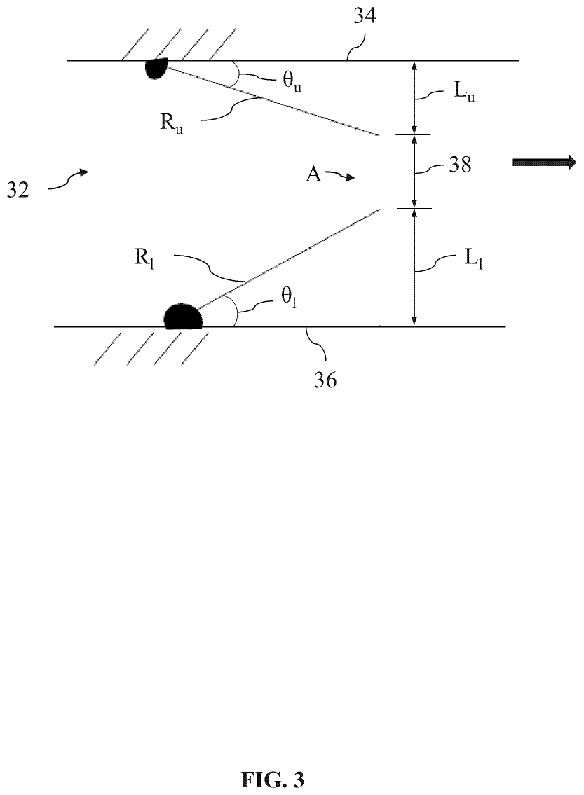

Referring to FIG. 3, in an embodiment, the air vent 28 includes an air nozzle 32. The air nozzle 32 may be recessed within the air vent 28 or extend from the air vent 28. The air nozzle 32 may include a flap R that can be orientated at an angle θ. In an embodiment, the air nozzle 32 may include an upper flap Rᵤ and a lower flap R₁ for directing the air flow from the air vent 28. The upper flap Rᵤ may be orientated at an upper angle θᵤ relative to an upper surface, plane, or pivot axis 34 of the air vent 28 upon which the upper flap Rᵤ is mounted or attached to the air vent 28. The lower flap R₁ may be orientated at a lower angle θ₁ relative to a lower surface, plane, or pivot axis 36 of the air vent 28 upon which the lower flap Rᵤ is mounted or attached to the air vent 28. The upper angle θᵤ and the lower angle θ₁ may be within a range of ±0-90 degrees, ±0-150 degrees, ±0-180 degrees, or the like, or a combination or sub-range thereof.

An upper flap distance Lᵤ is defined by a distance from the upper plane 34 to an end of the upper flap Rᵤ and a lower flap distance L₁ is defined by a distance from the lower plane 36 to an end of the lower flap Rᵤ. A cross-sectional flow area A having a flow area height 38 is defined by the upper flap distance Lᵤ and the lower flap distance L₁. In other words, the cross-sectional flow area A is defined by the upper flap Rᵤ, the upper angle θᵤ, the lower flap R₁ and the lower angle θ₁. A total height of the air vent 28 may be defined by the flow area height 38, the upper flap distance Lᵤ, and the lower flap distance L₁.

The air flow is thrust out of the air nozzle 32 and/or air vent 28 through the cross sectional area A. Adjusting the flow area height 38 adjusts the flow rate of the air flow from the air vent 28. For example, decreasing the flow area height 38 increases the flow rate of the air flow from the air vent 28, and vice versa. The direction of air flow from the air nozzle 32 and/or air vent 28 may be controlled by the orientation of the upper flap Rᵤ and the lower flap R₁. For example, the upper flap distance Lᵤ may be less than the lower flap distance L₁ (and/or the upper angle θᵤ may be less than the lower angle θ₁) such that the air flow is directed upwards or away from the lower plane 36 and towards the upper plane 34, and vice versa. When the upper angle θᵤ and the lower angle θ₁ are equal, the air flow is directed parallel to the upper plane 34 and lower plane 36. In this way, the air nozzle can control both the flow rate of the air flow and the direction of the air flow. In an embodiment, the air nozzle 32 is a thrust vector nozzle, or the like.

In an embodiment, the processor 14 is operatively connected to the air nozzle 32 and is programmed to adjust the orientation of the upper flap Rᵤ and the lower flap R₁ to direct the air flow to the out of range temperature location and to control the flow rate of the air flow from the air nozzle 32 and/or the air vent 28. The processor 14 may be programmed to send instructions to the air nozzle 32, a servo motor associated with the air nozzle, an actuator, or the like, to control the upper flap Rᵤ and the lower flap R₁. As described above, the processor 14 may be operatively connected to a plurality of air nozzles 32 and programmed to control the plurality of air nozzles 32 to direct the air flow toward the out of range temperature location and to control the flow rate of air flow from each the plurality of air nozzles 32. For example, the processor 14 may decrease the flow area height 38 of at least one of the plurality of air nozzles 32 greater than the flow area height 38 of another of the plurality of air nozzles 32, such that the flow rate of the air flow from the at least one of the plurality of air nozzles 32 is sufficient to adjust the elevated temperature or provide thermal comfort (e.g., the at least one of the plurality of air nozzles 32 may be further away from the out of range temperature location and require a greater thrust force or concentration of the air flow to affect the out of range temperature location). Similarly, the processor 14 may control the direction the air flow from the plurality of air nozzles 32 to the out of range temperature location by instructing the plurality of air nozzles 32 to orientate the respective upper flaps Rᵤ and the lower flaps R₁ at certain upper angles θᵤ and lower angles θ₁ irrespective of one another.

In an embodiment, the processor 14 may be programmed to determine a plurality of out of range temperature locations in response to the input data (X, Y, Z, T, Tₘ). The processor 14 may be programmed to determine a priority between the plurality of out of range temperature locations and to direct air flow from the plurality of air vents 28 according to the priority. For example, a first out of range temperature location may have an elevated temperature that is greater than the elevated temperature of a second out of range temperature location, and the processor 14 may direct the air flow from the plurality of air vents 28 toward the first out of range temperature location and then toward the second out of range temperature location (once the first out of range temperature location has reached the target temperature). In some embodiments, the processor 14 may be programmed to simultaneously direct air flow from the plurality of air vents 28 toward each of the plurality of out of range temperature locations. For example, the processor 14 may instruct a first set of the plurality of air vents 28 to be directed towards the first out of range temperature location and instruct a second set of the plurality of air vents 28 to be directed towards the second out of range temperature location. The first and second set of the plurality of air vents 28 may include the same or different numbers of air vents 28.

In view of the above, the processor 14 is programmed to automatically determine output variables (Xᵥ, Yᵥ, Zᵥ, 1, m_dot, θ, R) and send instructions to the plurality of servo motors 30, the plurality of air nozzles 32, the refrigerating system 26, and the blower motor 24. The output variables include the orientation or direction (Xᵥ, Yᵥ, Zᵥ) of the air vent 28, the output (1) of the blower motor 24, the flow of the refrigerant (m_dot), the flap R of an air nozzle 32, and the angle θ of the flap R.

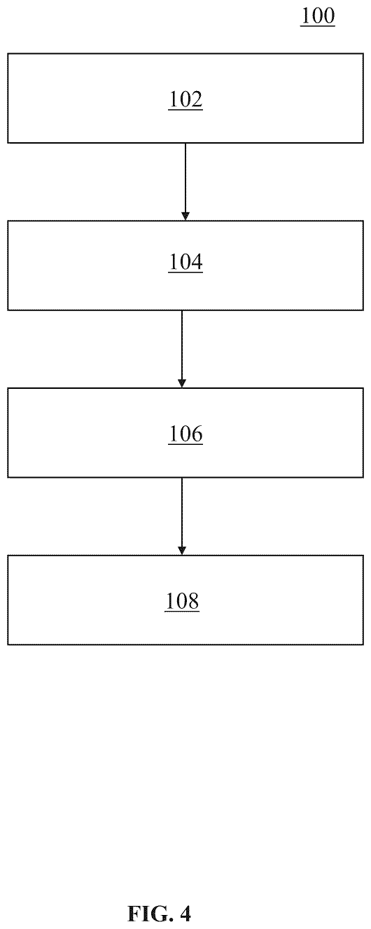

Referring to FIG. 4, in an embodiment, a method 100 of controlling thermal comfort of the passenger of the vehicle can be performed by the AC system 10. At 102, the out of range temperature location is identified on at least one passenger. In an embodiment, the identifying the out of range temperature location comprises providing input data (X, Y, Z, T, Tₘ) from the plurality of sensors 12 to the processor 14 and in response to receiving the input data (X, Y, Z, T, Tₘ) the processor 14 identifies the out of range temperature location on the at least one passenger. The plurality of sensors 12 may include at least one temperature sensor 16, at least one heat mapping sensor 18, and at least one position sensor 20. At 104, air flow is directed from at least one air vent 28 to the out of range temperature location. In an embodiment, the directing airflow from at least one air vent 28 comprises the processor 14 determining output variables (Xᵥ, Yᵥ, Zᵥ, 1, m_dot, θ, R) and directing air flow from the at least one of the plurality of air vents 28 to the out of range temperature location, wherein the output variables (Xᵥ, Yᵥ, Zᵥ, 1, m_dot, θ, R) include an air vent positioning (Xᵥ, Yᵥ, Zᵥ), air vent air flow speed, and or refrigerant flow rate (m_dot). The air flow speed may be determined by the output (1) of the blower motor 24 and the angle 0 of the flap R of an air nozzle 32. At 106, the air flow from the at least one air vent 28 continues until a target temperature is reached. For example, the processor 14 continues to direct the air flow from the at least one of the plurality of air vents 28 until the processor 14 determines a target temperature has been reached. At 108, once a target temperature is reached at the identified spot, then another spot is identified with an additional out of range temperature location on the passenger, and the process repeats again in an iterative manner. For example, the processor 14 identifies an additional out of range temperature location on at least one passenger.

In an embodiment, step 102 includes detecting an out of range temperature location through the at least one temperature sensor 16, the at least one heat mapping sensor 18, or the at least one position sensor 20 within the vehicle, or a combination thereof.

In an embodiment, step 104 includes controlling a servo motor 30 coupled to the at least one air vent 28 for directing air flow from the at least one air vent 28 to the out of range temperature location. In certain embodiments, a plurality of air vents 28 are simultaneously operated to direct air flow to the out of range temperature location. In instances where one location is identified, all of the plurality of air vents 28 could be operated to direct airflow to that location until a desired temperature is reached.

For example, a heat mapping sensor 18 may use thermal imaging to identify that the passenger's torso region has an elevated temperature (e.g., a hot spot) as compared to the rest of the passenger's body. The position sensor 20 would then identify the position data (X, Y, Z) of this identified hot spot. The direction of air flow from the air vents 28 would then be controlled and directed to this identified elevated temperature spot of the passenger's body, so that a cooling air flow can be routed to this location. Alternatively, a determination may regarding a lower temperature location, if a passenger's body is colder than other regions. The embodiments disclosed herein are intended to be inclusive of both heating and cooling control means for thermal comfort control of a passenger, although for purposes of brevity the embodiments described will predominantly refer to elevated temperatures and directing cooling air to elevated temperatures.

Referring to FIG. 1, in an embodiment, the AC system 10 includes a control panel 40 configured to receive input from the passenger and, in response to the input, to control the flow rate and/or direction of the air flow, the temperature of the air flow (e.g., the refrigerating system 26), or the like. The control panel 40 may be configured to override the processor 14 and/or set or adjust parameters for the processor 14 to control air flow within the vehicle. For example, the passenger may adjust the target temperature for specific locations within the vehicle or on the passenger's body. The control panel 40 reflects or may visually indicate changes to the AC system 10 (e.g., the output variables (Xᵥ, Yᵥ, Zᵥ, 1, m_dot, θ, R) or results thereof) made by the processor 14 in response to the input data (X, Y, Z, T, Tₘ).

In view of the above, the present disclosure describes systems and methods for the automatic control of thermal comfort within a vehicle. A passenger is not required to interact with the AC system 10, control panel 40, and/or the plurality of air vents 28 in order to cool or heat an out of temperature location within the vehicle or on the passenger. Accordingly, the passenger or other passengers are not distracted by thermal discomfort while operating or residing within the vehicle and are not distracted by efforts to adjust the AC system 10 to resolve the thermal discomfort.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

What is claimed:

1. A vehicle AC control system comprising:
at least one heat mapping sensor;
at least one position sensor;
at least one temperature sensor; and
at least one processor communicatively coupled to receive inputs from the at least one heat mapping sensor, the at least one position sensor, and the at least one temperature sensor, wherein the at least one processor is configured to direct airflow within the vehicle based on the inputs.

2. The system of claim 1, further comprising at least one servo motor coupled to at least one air vent within the vehicle for controlling air flow direction of the at least one air vent, wherein the at least one servo motor controls the air flow based on instructions from the at least one processor and the inputs.

3. The system of claim 1, wherein the at least one processor is programmed to identify an out of range temperature location on at least one passenger based on the inputs, and direct air flow from at least one air vent to the out of range temperature location.

4. The system of claim 1, wherein the processor of the AC control system receives input variables from the heat mapping sensor, the at least one position sensor, and the at least one temperature sensor, and determines output variables based on the input variables for at least one of air vent positioning, air vent air flow speed, and or refrigerant flow rate.

5. The system of claim 1, wherein the heat mapping sensor is an infrared thermal imaging camera.

6. The system of claim 1, wherein the at least one heat mapping sensor is mounted on a driver side location, a passenger side location, a rear vehicle location, or a combination thereof.

7. The system of claim 1, wherein the at least one heat mapping sensor is configured to provide heat mapping of a single passenger or multiple passengers.

8. The system of claim 1, wherein the at least one position sensor comprises a LIDAR sensor.

9. A method of controlling thermal comfort of a passenger in a vehicle, comprising:
identifying an out of range temperature location on at least one passenger,
directing air flow from at least one air vent to the out of range temperature location,
wherein the air flow from the at least one air vent continues until a target temperature is reached,
wherein identifying an out of range temperature location comprises detecting an out of range temperature location through at least one heat mapping sensor, at least one position sensor, or at least one temperature sensor within the vehicle, or a combination thereof.

10. The method of claim 8, wherein identifying an out of range temperature location comprises providing input variables from the heat mapping sensor, the at least one position sensor, and the at least one temperature sensor, to a processor of an AC unit of the motor vehicle.

11. The method of claim 8, wherein directing airflow from at least one air vent comprises determining output variables from a processor of an AC unit, wherein the output variables comprise air vent positioning, air vent air flow speed, or refrigerant flow rate.

12. The method of claim 8, wherein directing air flow from at least one air vent to the out of range temperature location, comprises controlling a servo motor coupled to at least one air vent for directing air flow from the at least one air vent to the out of range temperature location.

13. The method of claim 8, wherein the at least one heat mapping sensor is configured to provide heat mapping of a single passenger or multiple passengers.

14. The method of claim 8, further comprising, identifying an additional out of range temperature location on at least one passenger, once a target temperature is reached.

15. The method of claim 8, wherein the at least one heat mapping sensor is mounted on a driver side location, a passenger side location, a rear vehicle location, or a combination thereof.

16. An AC control system for a vehicle comprising:
a heat mapping sensor configured to generate a thermal map of a location within the vehicle;
a position sensor configured to identify the location within the vehicle;
a temperature sensor configured to detect an air temperature T within the vehicle;
a plurality of air vents for directing air flow from a blower;
a plurality of servo motors operatively coupled to a respective one of the plurality of air vents, wherein the plurality of servo motors are configured to adjust an orientation of the plurality of air vents;
a processor configured to receive input data from the heat mapping sensor, the position sensor, and the temperature sensor, wherein, in response to input data the processor is programmed to determine an out of range temperature location and to control at least one of the plurality of servo motors for adjusting the orientation of at least one of the plurality of air vents and directing the air flow from the at least one of the plurality of air vents towards the out of range temperature location.

17. The system of claim 16, wherein the plurality of air vents include an air nozzle having a flap and the processor is programmed to control an orientation of the flap for adjusting a flow rate of the air flow from the plurality of vents.

18. The system of claim 17, wherein the air nozzle is a thrust vector nozzle.

19. The system of claim 16, wherein blower is driven by a blower motor and the processor is programmed to control a flow rate of the air flow from the blower by adjusting an output of the blower motor.

20. The system of claim 16, further comprising a refrigerating system, wherein the processor is programmed to control a flow of a refrigerant within the refrigerating system.
